(19) United States
(12) Patent Application Publication
(10) Pub. No.: US 2024/0405307 A1
(43) Pub. Date: Dec. 5, 2024

(54) MODULATION STRATEGY FOR MAXIMIZATION OF BATTERY HEATING EFFICIENCY

(71) Applicant: GM GLOBAL TECHNOLOGY OPERATIONS LLC, DETROIT, MI (US)

(72) Inventors: Renato Amorim Torres, Pontiac, MI (US); Suresh Gopalakrishnan, Troy, MI (US); Lei Hao, Troy, MI (US); Chandra S. Namuduri, Troy, MI (US); Thomas W. Nehl, Shelby Twp., MI (US)

(21) Appl. No.: 18/327,231

(22) Filed: Jun. 1, 2023

(51) Int. Cl. H01M 10/615; B60L 50/51; H02M 7/5387

(52) U.S. Cl. CPC H01M 10/615; B60L 50/51; H02M 7/53873; B60L 2240/547

(57) ABSTRACT

A modulation strategy for maximization of battery heating efficiency is provided. A system includes an inverter coupled to a high voltage battery and a motor. A control system is coupled to the inverter. The control system is configured to control the inverter to output a first electrical current having a first triangular waveform to the motor, a second electrical current having a second triangular waveform to the motor, and a third electrical current to the motor. The first and second triangular waveforms are out of phase.

### INTRODUCTION

The disclosure relates to power control systems for a vehicle, and more particularly to providing an inverter modulation strategy for maximization of battery heating efficiency. Heating efficiency is defined as the heat dissipated inside the battery divided by the total power provided by the battery during the battery heating process.

In general, vehicles include many different electrical systems. These electrical systems include, but are not limited to, infotainment systems, lighting systems, power steering systems, power braking system, driver assistance systems, various sensors, heating systems, and air conditioning systems, and the like.

Recently, electric and hybrid vehicles have been developed which include high voltage (i.e., >400V) battery packs. Preconditioning the car battery of a vehicle involves warming the batteries up to an optimal temperature before charging or driving. Pre-heating the batteries increases the range for the same amount of stored energy, increases charging speed, and keeps the batteries healthy.

### SUMMARY

In one exemplary embodiment, a system is provided. The system includes an inverter coupled to a high voltage battery and a motor. The system includes a control system coupled to the inverter, where the control system is configured to control the inverter to output a first electrical current having a first triangular waveform to the motor, a second electrical current having a second triangular waveform to the motor, and a third electrical current to the motor, the first and second triangular waveforms being out of phase.

In addition to the one or more features described herein the control system is configured to cause switching at every half-cycle for the first triangular waveform and the second triangular waveform.

In addition to the one or more features described herein increasing a pulsation duty cycle of the first triangular waveform, the second triangular waveform, and a third waveform of the third electrical current increases heating of the high voltage battery.

In addition to the one or more features described herein the inverter includes a first set of switches, a second set of switches, and a third set of switches. The control system is configured to input at least a first modulated signal to the first set of switches, a second modulated signal to the second set of switches, and a third modulated signal to the third set of switches to cause the inverter to output the first triangular waveform, the second triangular waveform, and a third waveform, respectively, the first modulated signal and the second modulated signal causing an opposite logic signal in the first set of switches and the second set of switches.

In addition to the one or more features described herein the third electrical current has a third triangular waveform. Unbalanced phase relationships among the first triangular waveform, the second triangular waveform, and the third triangular waveform cause heating of the high voltage battery.

In addition to the one or more features described herein the unbalanced phase relationships draw alternating current from the high voltage battery in order to generate the heating in the high voltage battery.

In addition to the one or more features described herein a combination of the first, second, and third electrical currents does not create any q-axis motor current such that no electromagnetic torque is generated in the motor of a vehicle.

In one exemplary embodiment, a system is provided. The system includes an inverter coupled to a high voltage battery and a motor, the inverter including a first set of switches, a second set of switches, and a third set of switches coupled to the high voltage battery. The system includes a control system coupled to the inverter, the control system having a memory having computer readable instructions and a processing device for executing the computer readable instructions in the memory. The control system is configured to control the first set of switches of the inverter to output a first electrical current having a first triangular waveform to the motor, control the second set of switches of the inverter to output a second electrical current having a second triangular waveform to the motor, and control the third set of switches of the inverter to output a third electrical current to the motor, the first and second triangular waveforms being out of phase.

In addition to the one or more features described herein the control system is configured to cause switching at every half-cycle for the first triangular waveform and the second triangular waveform.

In addition to the one or more features described herein increasing a pulsation duty cycle of the first triangular waveform, the second triangular waveform, and a third waveform of the third electrical current increases heating of the high voltage battery.

In addition to the one or more features described herein the control system is configured to input at least a first modulated signal to the first set of switches, a second modulated signal to the second set of switches, and a third modulated signal to the third set of switches to cause the inverter to output the first triangular waveform, the second triangular waveform, and a third triangular waveform, respectively, the first modulated signal and the second modulated signal causing an opposite logic signal in the first set of switches and the second set of switches.

In addition to the one or more features described herein the third electrical current has a third triangular waveform. Unbalanced phase relationships among the first triangular waveform, the second triangular waveform, and the third triangular waveform cause heating of the high voltage battery.

In addition to the one or more features described herein the unbalanced phase relationships draw alternating current from the high voltage battery in order to generate the heating in the high voltage battery.

In addition to the one or more features described herein a combination of the first, second, and third electrical currents does not create any q-axis motor current such that no electromagnetic torque is generated in the motor of a vehicle.

In one exemplary embodiment, a method is provided for heating a high voltage battery. The method includes causing, by a control system, an inverter to output a first electrical current having a first triangular waveform to a motor. The method includes causing, by the control system, the inverter to output a second electrical current having a second triangular waveform to the motor, the first and second triangular waveforms being out of phase. The method includes causing, by the control system, the inverter to output a third electrical current to the motor, the first electrical current, the second electrical current, and the third electrical current being drawn from a high voltage battery.

In addition to the one or more features described herein the control system is configured to cause switching at every half-cycle for the first triangular waveform and the second triangular waveform.

In addition to the one or more features described herein increasing a pulsation duty cycle of the first triangular waveform, the second triangular waveform, and a third waveform of the third electrical current increases heating of the high voltage battery.

In addition to the one or more features described herein the inverter includes a first set of switches, a second set of switches, and a third set of switches. The control system is configured to input at least a first modulated signal to the first set of switches, a second modulated signal to the second set of switches, and a third modulated signal to the third set of switches to cause the inverter to output the first triangular waveform, the second triangular waveform, and a third triangular waveform, respectively, the first modulated signal and the second modulated signal causing an opposite logic signal in the first set of switches and the second set of switches.

In addition to the one or more features described herein the third electrical current has a third triangular waveform; and unbalanced phase relationships among the first triangular waveform, the second triangular waveform, and the third triangular waveform cause heating of the high voltage battery.

In addition to the one or more features described herein the unbalanced phase relationships draw alternating current from the high voltage battery in order to generate the heating in the high voltage battery.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle for use in conjunction with one or more embodiments of the present disclosure;

FIG. 2 is a schematic illustration of a vehicle electric drive system in accordance with an exemplary embodiment;

FIG. 3 is a block diagram illustrating a control system connected to a power supply system and motor for a vehicle in accordance with an exemplary embodiment;

FIG. 4A is a graph illustrating gate logic signals over time for switches of an inverter for a vehicle in accordance with another exemplary embodiment;

FIG. 4B is a graph illustrating battery and DC-link current over time in accordance with another exemplary embodiment;

FIG. 4C is a graph illustrating DC-link voltage over time in accordance with another exemplary embodiment;

FIG. 4D is a graph illustrating motor three phase currents over time in accordance with another exemplary embodiment;

FIG. 4E is a graph illustrating motor three phase voltages over time in accordance with another exemplary embodiment;

FIG. 4F is a graph illustrating motor d-axis and q-axis currents over time in accordance with another exemplary embodiment;

FIG. 5A is a graph illustrating battery current drawn from the battery over time in accordance with another exemplary embodiment;

FIG. 5B is a graph illustrating three phase motor currents over time in accordance with another exemplary embodiment;

FIG. 5C is a graph illustrating moving average of battery internal heat over time in accordance with another exemplary embodiment;

FIG. 5D is a graph illustrating moving average of heating efficiency of the battery over time in accordance with another exemplary embodiment;

FIG. 6 is a flowchart of a computer-implemented heating efficiency determination method for heating the battery in accordance with an exemplary embodiment;

FIG. 7 is a flowchart of a computer-implemented method for executing a modulation strategy for maximization of battery heating efficiency in accordance with an exemplary embodiment;

FIG. 8 depicts a computer system used to implement features discussed herein in accordance with an exemplary embodiment;

FIG. 9 depicts a chart of voltage space vectors in accordance with an exemplary embodiment;

FIG. 10 depicts a chart of voltage space vectors in accordance with an exemplary embodiment;

FIG. 11 depicts a chart of voltage space vectors in accordance with an exemplary embodiment;

FIG. 12A is a graph illustrating battery current drawn from the battery over time in accordance with another exemplary embodiment;

FIG. 12B is a graph illustrating three phase motor currents over time in accordance with another exemplary embodiment;

FIG. 12C is a graph illustrating moving average of battery internal heat over time in accordance with another exemplary embodiment; and

FIG. 12D is a graph illustrating moving average of heating efficiency of the battery over time in accordance with another exemplary embodiment.

### DETAILED DESCRIPTION

The following description is merely exemplary in nature and is not intended to limit the present disclosure, its application or uses.

The disclosed improvements relate to self-heating of the battery pack by generating an alternating current (AC) current through the battery pack from energy stored within the battery pack. Such technique may generally be referred to as AC heating and works by passing the AC current through the battery pack's internal resistance (i.e., through each cell's internal resistance), which causes the battery pack to heat up due to the heat generated by the internal resistance. In embodiments described herein, existing reactive loads of the motor in a propulsion system of a vehicle are utilized in efficiently self-heating of the battery pack. More particularly, the phase windings of the motor may be utilized to store electrical energy from the battery pack and return the energy to the battery pack thereby effecting internal ohmic heating of the battery pack. In embodiments described herein a perturbation in the DC link which couples the battery pack to the power inverter effects an AC current through the battery pack. A perturbation in the direct current (DC) link may be caused by generating unbalanced phase voltages in the phase windings. AC resistance heating may be used to control the battery pack temperature to a predetermined range for a battery discharge or recharge event. In accordance with the present disclosure, it is generally desirable to thermally precondition the battery pack in order that the vehicle is made ready to drive or recharge with the battery pack within an advantageous temperature range.

Battery AC heating methods may deliver poor performance without optimization of AC current shape, frequency, and amplitude because the generated heat may be concentrated in other components such as the electric machine (i.e., motor) and power converter instead of battery.

According to one or more exemplary embodiments, a modulation and control strategy is provided to maximize battery heating efficiency of AC current injection heating strategy. The control strategy delivers optimal DC-link current waveform and regulates heat distribution between the battery and motor. Exemplary embodiments can optimize the shape, frequency, and amplitude of the DC-link AC current to boost the battery heating efficiency.

Technical effects and solutions include utilization of triangular shaped phase currents that have fundamental and harmonic components of frequencies below the resonant frequency created by DC-link capacitance and inductance in series with battery branch. Therefore, these current components are poorly filtered out by the DC-link circuit and draw current primarily from the battery thereby improving the heating efficiency of the battery. In accordance with one or more embodiments, the control strategy ensures that operation is at high heating efficiency points. In one or more exemplary embodiments, the modulation strategy may reduce switching events during AC heating by approximately 66%, thereby reducing losses in the inverter.

As further technical effects and solutions, the high heating efficiency operating points can be achieved by regulating the fundamental frequency of the triangular shaped phase currents. The modulation strategy can enable zero electromagnetic torque by only injecting d-axis current to the motor while not injecting q-axis current to the motor. It is recognized that the q-axis current components primarily produce torque upon the rotor whereas the d-axis current components primarily do not. Technical effects and solutions warm the batteries of a vehicle up to an optimal temperature before charging them. Pre-heating the batteries preserves energy, increases charging speed, and keeps the batteries healthy.

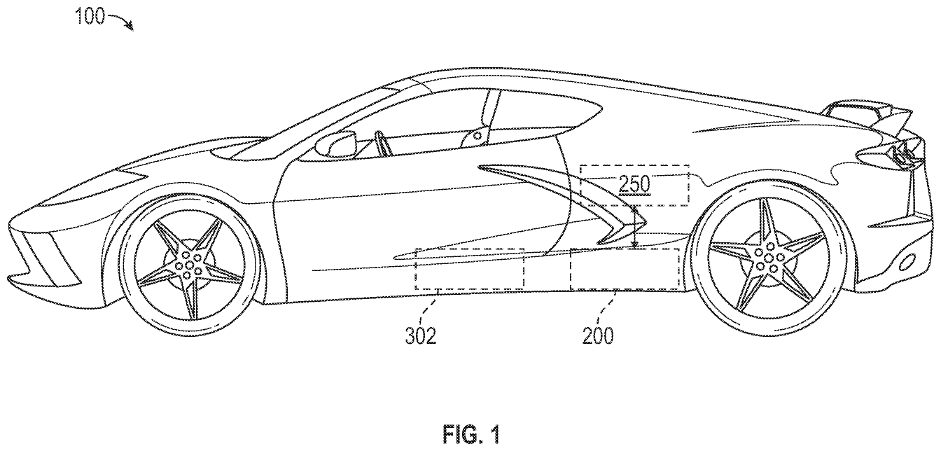

Referring now to FIG. 1, a schematic diagram of a vehicle 100 for use in conjunction with one or more embodiments of the present disclosure is shown. The vehicle 100 includes a power supply system 200. In one embodiment, the vehicle 100 is a hybrid vehicle that utilizes both an internal combustion engine and an electric motor drive system. In another embodiment, the vehicle 100 is one of an electric vehicle propelled only by an electric motor or multiple electric motors 250. In another embodiment, the vehicle 100 is of conventional type and propelled by an internal combustion engine.

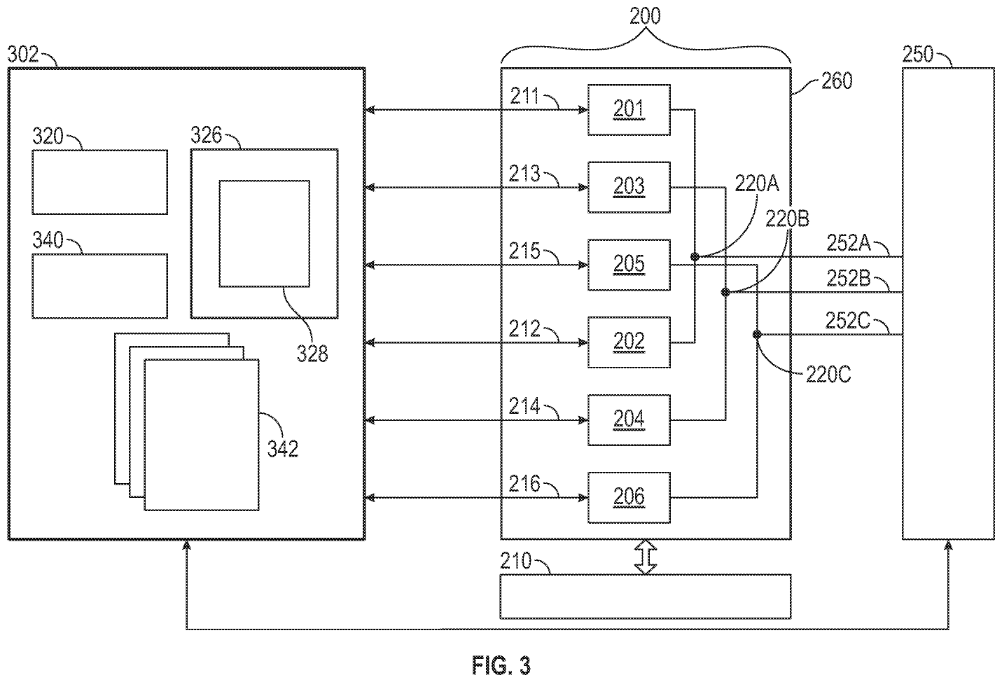

Electric vehicles (EVs) such as battery electric vehicles (BEVs), hybrid vehicles, and/or fuel cell vehicles include one or more electric machines and a high-voltage battery pack. A power control system 302 (depicted in FIG. 3) is used to control charging and/or discharging of the high-voltage battery system. The power control system includes an accessory power module (APM) that is configured to provide low-voltage power to one or more electrical systems of the vehicle. Although vehicles and vehicle systems are discussed herein, such terms are not meant to be limiting. In one or more embodiments, vehicles or vehicle systems can include all systems with a rechargeable battery and a drive unit, including but not limited to electric planes, boats, farm/construction equipment, trains, motorcycles, lawn equipment, etc.

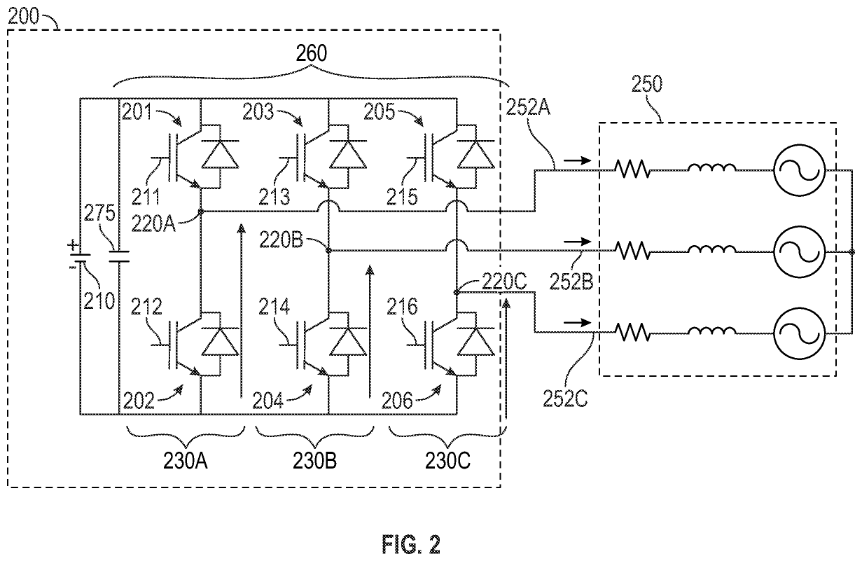

Referring now to FIG. 2, a block diagram illustrating a portion of power supply system 200 for a vehicle in accordance with an exemplary embodiment is shown. The power supply system 200 includes a high voltage battery 210. The high voltage battery 210 may include high voltage battery modules having batteries that are connected in series to form a high voltage battery pack. The high voltage battery pack may be connected to a DC/DC converter (not shown) that is configured to provide a reduced/increased, or low/high voltage, to a low/high voltage bus or to a low/high voltage battery.

In FIG. 2, the power supply system 200 is connected to a motor 250. The power supply system 200 includes switches 201, 203, and 205 that are complementary to switches 202, 204, and 206, respectively. The switch 201 can be referred to as switch 1 or SW1, switch 203 can be referred to as SW3, and switch 205 can be referred to as SW5. Similarly, the switch 202 can be referred to as SW2, switch 204 can be referred to as SW4, and switch 206 can be referred to as SW6.

The switches 201, 203, 205, 202, 204, and 206 are each illustrated as an IGBT in anti-parallel with a diode. As the input terminals to the switches, the gates of the switches 201, 203, and 205 are designated as inputs 211, 213, and 215, respectively. Similarly, as the input terminals to the complementary switches, the gates of the switches 202, 204, and 206 are designated as inputs 212, 214, and 216, respectively. It is noted that switches in the same leg (e.g., switch 201 (S1) and switch 202 (S2)) are connected together and have a complementary operation (i.e., if switch 201 (S1) is ON then switch 202 (S2) is OFF, and vice-versa) following traditional voltage source inverter (VSI) operation. It is understood that some deadtime may be added as a margin between the time that one switch turns on and the complementary switch turns off (and vice versa), as understood by one of ordinary skill in the art. The inverter 260 is illustrated with three legs.

In FIG. 2, leg 230A includes the switches 201 and 202 coupled in series with output node 220A, leg 230B includes the switches 203 and 204 coupled in series with output node 220B, and leg 230C includes the switches 205 and 206 coupled in series with output node 220C. Legs 230A, 230B, and 230C in the inverter 260 are commonly referred to as legs A, B, and C, respectively. The output nodes 220A, 220B, and 220C of legs 230A, 230B, and 230C respectively connect to input terminals 252A, 252B, and 252C of the motor 250, thereby providing three-phase electrical current to the motor 250. The motor 250 may be represented has having a resistor, an inductor and a back-electromotive force (emf) voltage source through which current flows.

Since the two switches in each leg operate in a complementary manner, some example scenarios may only discuss the operation of one of the switches in each leg 230A, 230B, and 230C such as switches 201, 203, and 205 commonly referred to as SW1, SW3, and SW5, but it is understood that the description applies by analogy to the switches 202, 204, and 206 (commonly referred to as SW2, SW4, and SW6) in a complementary relationship.

Referring now to FIG. 3, a block diagram illustrating the power supply system 200 connected to the control system 302 in accordance with an exemplary embodiment is shown. The control system 302 is configured to provide a modulation and control strategy to the power system 200 in order to maximize battery heating of the battery 210. The control system 302 includes one or more processors 320, memory 326, one or more software modules 328 stored in or coupled to the memory 326, and a driver 340. The driver 340 is configured to provide input signals to the inputs 211, 213, and 215 of respective switches 201, 203, and 205 and complementary input signals to the inputs 212, 214, and 216 of respective switches 202, 204, and 206. The software module 328 controls the driver 340 to output the signals to the switches. The driver 340 can be a signal generator that is controlled by software module 328 to output voltage and current as understood by one of ordinary skill in the art. The driver 340 may be representative of multiple drivers, for example, one driver for each switch. As noted above, using the driver 340, the software module 328 controls the switches in the same leg (e.g., switches 201 and 202 in leg 230A) to have a complementary operation (i.e., if switch 201 is ON then switch 202 is OFF and vice-versa) following traditional VSI operation. It is understood that some deadtime may be added as a margin between the time that one switch turns on and the complementary switch turns off (and vice versa), as understood by one of ordinary skill in the art.

Any of the modules in the control system 302 including the software module 328 can be implemented as instructions stored on a computer-readable storage medium, as hardware modules, as special-purpose hardware (e.g., application specific hardware, application specific integrated circuits (ASICs), as embedded controllers, hardwired circuitry, etc.), and/or as some combination or combinations of these. In examples, the modules can be a combination of hardware and programming. The programming can be processor executable instructions stored on a tangible memory, and the hardware can include processing circuitry (e.g., processors) for executing those instructions. Thus, a system memory can store program instructions that when executed by processing circuitry implement the modules described herein. Alternatively, or additionally, the modules can include dedicated hardware, such as one or more integrated circuits, Application Specific Integrated Circuits (ASICs), Application Specific Special Processors (ASSPs), Field Programmable Gate Arrays (FPGAs), and/or any combination of the foregoing examples of dedicated hardware, for performing the techniques described herein.

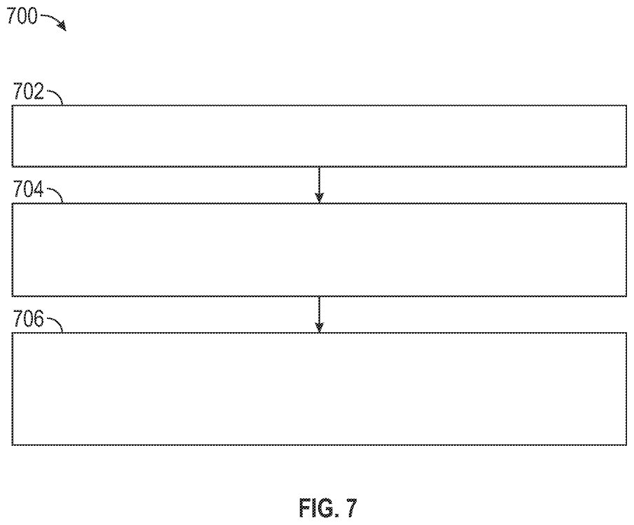

The control system 302 can include any of the functionality including software and hardware components discussed in a computer 140 depicted in FIG. 8 and discussed further herein.

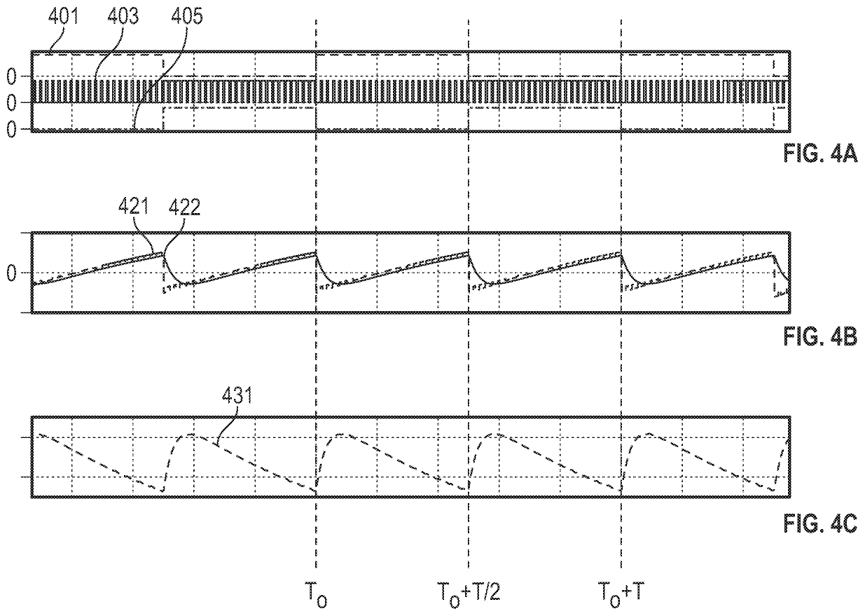

During operation, the software module 328 of the control system 302 receives as input rotor position angle and motor phase currents of the motor 250 and outputs gate signals for switches 201, 203, 205, 202, 204, and 206. During the modulation strategy of the inverter 260, two inverter legs (e.g., legs 230A and 230C) will only change its state twice in a period (T) (when (T₀) is 0 the period is T but when (T₀) is greater than 0, the period can be represented as T₀+T) as depicted in FIG. 4A. The state transition of these two legs only occurs at the beginning of the cycle (T₀) and at half of the cycle (T₀+T/2). Those two legs will be hereafter referred as “clamped legs”. As noted above, example scenarios may only discuss switches 201, 203, and 205 (e.g., SW1, SW2, and SW3) because their operation is complementary to switches 202, 204, and 206. FIG. 4A is a graph that illustrates the logic signals for gate voltage input signals to switches 201, 203, and 205 (e.g., SW1, SW2, and SW3) but applies in a complimentary operation to switches 202, 204, and 206 according to one or more embodiments. FIG. 4A shows the logic level on the y-axis and time on the x-axis. Waveforms 401, 403, and 405 each show the pulse width modulation of respective gate signals. For explanation purposes, legs 230A and 230C (e.g., switches 201 (SW1) and 205 (SW5)) are clamped in example scenarios, but it is understood that the definition of the two legs that will be clamped depends on the rotor position of the motor 250. FIG. 4A represents the logic signals of the gate voltage input to the inputs 211, 213, and 215. As the gate voltage to input 211 of the switch 201, the control system 302 outputs a high voltage signal for half the cycle (e.g., from T₀ to T₀+T/2) and a low voltage signal for the other half of the cycle (e.g., from T₀+T/2 to T), which results in the switch 201 operating with a logic signal illustrated by waveform 401. In other words, the control system 302 turns on the switch 201 for half the cycle (e.g., from T₀ to T₀+T/2) and turns off the switch 201 for the other half of the cycle (e.g., from T₀+T/2 to T).

As the gate voltage to input 215 of the switch 205, the control system 302 outputs a low voltage signal for half the cycle (e.g., from T₀ to T₀+T/2) and a high voltage signal for the other half of the cycle (e.g., from T₀+T/2 to T), which results in the switch 205 operating with a logic signal illustrated by waveform 405. In other words, the control system 302 turns off the switch 205 for half the cycle (e.g., from T₀ to T₀+T/2) and turns on the switch 205 for the other half of the cycle (e.g., from T₀+T/2 to T). Because the switch 205 is complementary to switch 201 (i.e., leg 230A is complementary to leg 230C), the waveform 405 illustrates an opposite logic signal operation for switch 205 than switch 201, such that when one switch (i.e., one leg) is powered on, the other switch (i.e., the other leg is powered off)

In FIG. 4A, the gate input signal to the gate input 213 of switch 203 is switching rapidly between a high voltage signal and a low voltage signal much faster than the gate input signals for switches 201 and 205. This results in the logic signal for the switch 203 being illustrated by the waveform 403, and the switch 203 is commuting at a predetermined frequency. The input gate signals to inputs 211, 213, and 215 from the control system 302 are complementary to the input gate signals to the inputs 212, 214, and 216, which do not have their logic signals shown in FIG. 4A. In FIG. 2, the switches 201, 203, and 205 and the switches 202, 204, and 206 each include an insulated-gate bipolar transistors (IGBT). In one or more embodiments, the switches 201, 203, and 205 and the switches 202, 204, and 206 may include n-type metal oxide semiconductor field effect transistor (MOSFET) or NFET and other types of power switches. To power on the respective switches, the control system 302 applies a high voltage signal (e.g., logical high 1) to the respective gate inputs; to power off the respective switches, the control system 302 applies a low voltage signal (e.g., logical low 0) to the respective gate inputs. In accordance with the modulated signals output from the control system 302 to the respective gate inputs 211, 213, and 215 of the respective switches 201, 203, and 205, FIG. 4D illustrates the electrical motor currents of the motor (for different phases) at the input terminals 252A, 252B, and 252C as triangular waveform 411, triangular waveform 413, and triangular waveform 415, respectively.

FIG. 4D is a graph that represents the three-phase currents output by the inverter 260 to the motor 250 according to one or more embodiments. As can be seen, the output nodes 220A, 220B, and 220C of legs 230A, 230B, and 230C output electrical currents having predetermined waveforms. For example, leg 230A formed of switches 201 and 202 outputs a triangular waveform 411 at output node 220A. Similarly, leg 230C formed of switches 205 and 206 outputs a triangular waveform 415 at output node 220C. Leg 230B outputs a triangular waveform 413 at output node 220B. In one or more embodiments, any one of the triangular waveform 411, the triangular waveform 413, or the triangular waveform 415 may have zero amplitude under certain rotor positions.

FIG. 4B illustrates a graph of the battery and DC-link current. FIG. 4B illustrates current (A) on the y-axis and time on the x axis. The waveform 421 is the DC link current (sum of currents across switches 201, 203 and 205), and the waveform 422 is the battery current. FIG. 4C is a graph illustrating the DC link voltage. FIG. 4C illustrates voltage (V) on the y-axis and time on the x-axis, where the waveform 431 is the DC-link voltage. FIG. 4D is a graph illustrating three phase motor currents, where the y-axis is current and the x-axis is time. FIG. 4E is a graph illustrating three phase motor line to line voltages, where voltage is on the y-axis and time is on the x-axis. In FIG. 4E, the waveforms 440, 441, and 442 are line to line motor terminal voltages. The first waveform 440 is line to line voltage measured from terminal 252A to terminal 252B, the second waveform 441 is line to line voltage measured from terminal 252B to terminal 252C, and the third waveform 442 is line to line voltage measured from terminal 252C to terminal 252A. FIG. 4F is a graph illustrating the motor D-axis current and the Q-axis current, where the y-axis is current and the x-axis is time. The waveform 430 is the Q-axis current, while the waveform 432 is the D-axis current.

As seen in FIGS. 4A, 4B, 4C and 4D which are aligned in time, the control system 302 is configured to provide a modulation and control strategy of the three-phase inverter 260 to maximize battery heating efficiency of the battery 210. The modulation strategy produces unbalanced triangular-shaped three-phase currents at the output of the inverter 260 such as the output nodes 220A, 220B, and 220C. The unbalanced phase currents draw an AC current from the DC-link shown as the triangular waveform 421. The AC current drawn from the DC-link creates a perturbation in the DC link voltage shown as the distorted triangular shaped waveform 431. The DC link voltage perturbation effects an AC current through the battery pack shown as distorted triangular shaped waveform 422.

The AC current, shown as distorted triangular shaped waveform 422, is drawn from the battery 210, which generates the heat inside the battery 210 in accordance with one or more embodiments. According to one or more embodiments, the modulation and control strategy optimizes the shape, frequency, amplitude, and pulsation duty cycle (defined next) of the three phase AC currents at the output of the inverter to boost the battery heating efficiency.

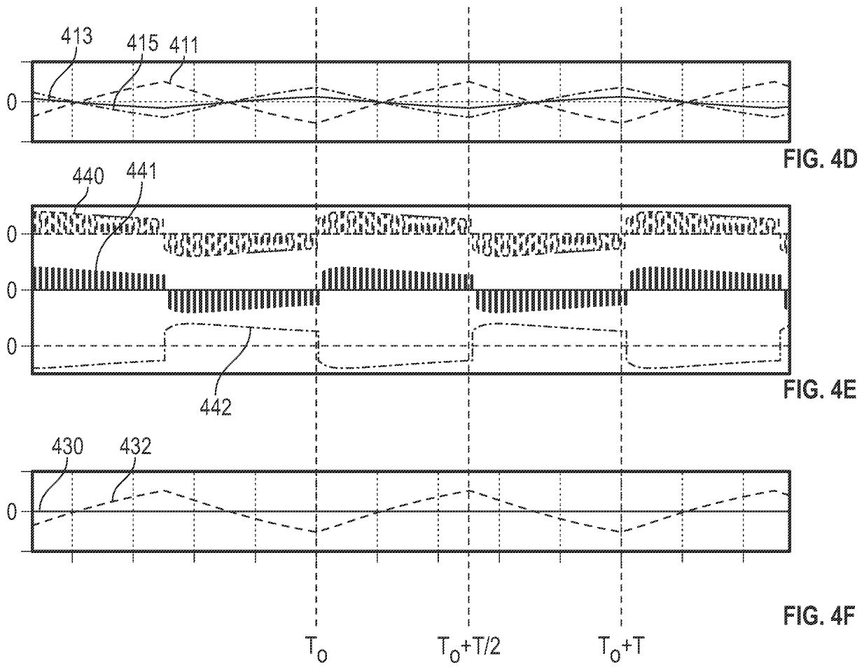

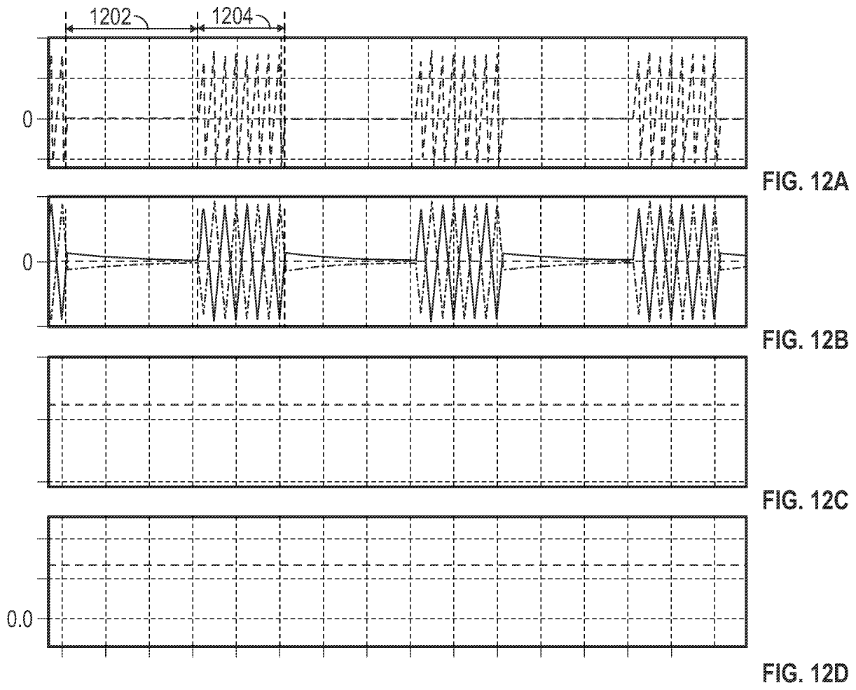

FIG. 5A illustrates the instantaneous battery current drawn from the battery 210 over time (seconds(s)). FIG. 5A is a graph illustrating current on the y-axis and time on the x-axis. FIG. 5B is a graph illustrating three phase motor currents, with current on the y-axis and time on the x-axis. FIG. 5C illustrates the moving average of the battery internal heat (i.e., power dissipated inside the battery that would lead to a temperature increase) over time, and FIG. 5D illustrates the moving average of the heating efficiency of the battery over time according to one or more embodiments. FIG. 5C illustrates heat in watts (W) on the y-axis and time on the x-axis. It should be appreciated that FIGS. 5A and 5B show a pulsation duty cycle. Further discussion of the pulsation duty cycle is illustrated in FIG. 12A, 12B, 12C, and 12D. In FIGS. 12A and 12B, interval 1202 represents time (T) inactive while interval 1204 represent T active. The intervals 1202 and 1204 alternate in time.

The pulsation duty cycle can be defined as the ratio between active intervals T_{active} and the sum of the active intervals T_{active} and inactive intervals T_{inactive} (pulsation duty cycle corresponds to T_{active}/(T_{active}+T_{inactive})). During a pulsating operation the inverter 260 will have its operation alternated between active intervals where it outputs currents as defined by the waveform determination stage 654 and intervals, where the current will be maintained at zero. FIGS. 12A, 12B, 12C, and 12D exemplify a pulsating operation and identifies the active and inactive intervals. FIG. 12A is a graph illustrating battery current drawn from the battery over time in accordance with another exemplary embodiment. In FIG. 12A, current is on the y-axis and time is on the x-axis. FIG. 12B is a graph illustrating three phase motor currents over time in accordance with another exemplary embodiment. In FIG. 12B, current is on the y-axis and time is on the x-axis. FIG. 12C is a graph illustrating moving average of battery internal heat over time in accordance with another exemplary embodiment. In FIG. 12C, heat in watts is on the y-axis and time is on the x-axis. FIG. 12D is a graph illustrating moving average of heating efficiency of the battery over time in accordance with another exemplary embodiment. In FIG. 12D, heating efficiency (%) is on the y-axis and time is on the x-axis. Despite the fact FIGS. 12C and 12D do not show a pulsation in their waveforms, they are averaging out the heat and heating efficiency of the pulsating operation, respectively.

In FIG. 5A, the control system 302 causes the battery 210 to operate at very high current for short bursts of times to reduce the average power, which is regulated by the pulsation duty cycle. The pulsation duty cycle and the instantaneous high currents (depicted in FIG. 5A) drawn from the battery 210 regulate the battery heating power while allowing operation at maximum heating efficiency. As seen in FIG. 5A, the instantaneous currents are high to allow high heating efficiency depicted in FIG. 5D; however, average current and power are regulated based on the pulsed duty cycle. FIG. 5D is a graph illustrating moving average heat efficiency, where heating efficiency (%) is on the y-axis and time is on the x-axis. FIG. 5B is analogous to FIG. 4D. However, FIG. 5B is a graph that represents the three-phase currents output by the inverter 260 to the motor 250 over many periods or a longer duration of time than the period illustrated in FIG. 4D. In addition, in FIG. 4D the pulsation duty cycle is equal to one (i.e., inverter 260 is always in active operation), while in FIG. 5B the pulsation duty cycle is increased overtime from 0.2 to 1 in steps of 0.2.

When the control system 302 increases a pulsation duty cycle of the first triangular waveform output at terminal 252A, the second triangular waveform output at terminal 252C, and the third triangular waveform output at terminal 252B, the increased pulsation duty cycle increases the internal heat of the battery 210 in FIG. 5C while maintaining a high average heating efficiency (e.g., about 65%) in FIG. 5D. The pulsation duty cycle can be increased for the first triangular waveform output at terminal 252A, the second triangular waveform output at terminal 252C, and the third triangular waveform output at terminal 252B, thereby increasing the heating of the battery.

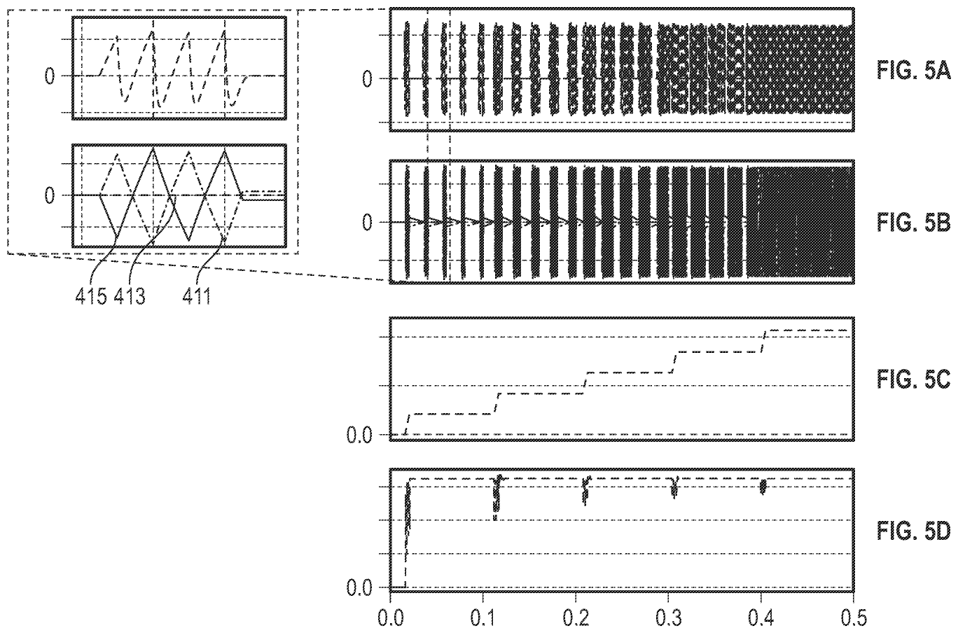

FIG. 6 is a flowchart for computer-implemented heating efficiency determination method 600 for heating the battery according to one or more embodiments. Heating efficiency is defined as the heat dissipated inside the battery divided by the total power provided by the battery during the battery heating process. The software module 328 of the control system 302 is configured to receive various inputs and make decisions based on the inputs to control the inverter 260 as discussed herein. The control system 302 performs the heating efficiency determination method 600 to heat the battery 210 as discussed herein. For explanation purposes and not limitation, the heating efficiency determination method 600 is illustrated to include a heating rate determination stage 650, a heating efficiency determination stage 652, a waveform determination stage 654, and a pulsation duty cycle determination stage 656, where each stage is separated by dashed lines as shown in FIG. 6.

At block 602 of the heating rate determination stage 650, the control system 302 is configured to receive real time input variables/parameters. The real time input variables/parameters include the ambient temperature, battery temperature, motor temperature, rotor temperature (observer estimation +lookup table for rotor loss), as understood by one of ordinary skill in the art. The value for the rotor loss can be obtained from one of the lookup tables 342 based on motor's operating point. At block 604, the control system 302 is configured to utilize temperature based derating methods as understood by one of ordinary skill in the art. An example temperature based derating method includes limiting the battery heating power to avoid that the flux created by large stator currents may demagnetize the rotor magnets at high temperatures. At block 606, the control system 302 is configured to provide the requested battery heating power P*_{bat} and requested motor heating power P*ₘₒₜ signals to the heating efficiency determination stage. These signals are calculated based on signals from 602 and 604. P*_{bat} is defined as the requested heat power dissipated inside the battery. P*ₘₒₜ is defined as the requested heat power dissipated inside the motor. It is noted that the variables with “*” correspond to requests by the controller.

In some conditions, it may be desirable to heat up not only the battery, but also the motor. For example, the heat dissipated in the motor can be used to indirectly warm up the battery via cooling loops available in the vehicle (in other words the heat dissipated in the motor is transported to the battery).

At block 614 of the heating efficiency determination stage 652, the control system 302 is configured to perform calculations, where total requested power is P*ₜₒₜ=P*_{bat}+P*ₘₒₜ and where requested heating efficiency:

$$( {η}^{*} = \frac{{P}_{bat}^{*}}{{P}_{tot}^{*}} ) .$$

It is noted that P*ₜₒₜ corresponds to the power drawn from the battery 210.

At block 608 of the waveform determination stage 654, the control system 302 is configured to receive design parameters for developing the lookup tables 342. The design parameters include the maximum (max) battery current, the maximum capacitor current (i.e., DC-link current), and the maximum DC-link voltage. At block 610, the control system 302 is configured to receive a real time input variable/parameter which is battery voltage (V_{bat}). At block 612, the control system 302 is configured to perform a lookup in the lookup tables 342 for input: battery voltage (V_{bat}) and for output: maximum (max) available heating efficiency (ηₘₐₓ) and corresponding maximum triangular waveform period (Tₘₐₓ) and maximum battery heating power (P_{bat,max}).

At block 616 of the waveform determination stage 654, the control system 302 is configured to perform a check of whether the requested heating efficiency is greater than the maximum (available) heating efficiency η*>ηₘₐₓ defined by block 612. The maximum heating efficiency ηₘₐₓ is the maximum heating efficiency for the heating of battery 210 that can be produced using the modulation and control strategy according to one or more embodiments given practical constraints such as the ones defined in block 608. The requested heating efficiency for the battery is η*. At block 618, when (Yes) the requested heating efficiency η* is greater than the maximum (available) heating efficiency ηₘₐₓ, the control system 302 is configured to determine that the inverter 260 is to be controlled such that electrical currents are output with triangular waveforms (e.g., such as triangular waveforms 411, 413 and 415) from the inverter 260 at the nodes 220A, 220B and 220C, the period of the output triangular electrical currents is Tₘₐₓ defined in block 612. At block 620, when (No) the requested heating efficiency η* is less than the maximum (available) heating efficiency ηₘₐₓ, the control system 302 is configured to determine that inverter 260 is to be controlled according to option 1 or option 2. In option 1, the control system 302 controls the inverter 260 such that electrical currents are output with the triangular waveforms (e.g., such as triangular waveforms 411, 413 and 415) from the inverter 260 at the nodes 220A, 220B and 220C, the period of the output triangular currents is T, where T is smaller than Tₘₐₓ. T is based on a lookup in the lookup tables 342 for the input heating efficiency η*. In option 2, the control system 302 controls the inverter 260 such that electrical currents are output with sinusoidal waveforms or distorted sinusoidal waveforms (overmodulation or sinusoidal +harmonics) (in place of the triangular waveforms 411, 413 and 415) from the inverter 260 at the nodes 220A, 220B and 220C, the fundamental frequency of the output sinusoidal electrical currents is frequency f, the amplitude is A based on a lookup in the lookup tables 342 for the input heating efficiency η*.

At block 621 of the pulsation duty cycle determination stage 656, the estimation of the average cycle power P_{cycle} for the given waveform shape and period (or frequency) is computed based on lookup tables or based on physics-based estimations. The average cycle power P_{cycle} is defined as the average power provided by the battery to heat the battery and motor computed over one period T of the triangular or sinusoidal waveforms.

At block 622 of the pulsation duty cycle determination stage 656, the control system 302 is configured to perform a check of whether P*ₜₒₜ>Pc_{ycle}. The total power P*ₜₒₜ is the total power requested by the user, such as a reference power, as calculated in block 614. At block 624, when (Yes) the total power P*ₜₒₜ requested is greater than the average cycle power P_{cycle}, the control system 302 is configured to control the inverter 260 with a pulsation duty cycle=1, meaning no inactive intervals. FIG. 4 exemplifies such condition. At block 626, when (No) the total power P*ₜₒₜ requested is less than the average cycle power P_{cycle}, the control system 302 is configured to control the inverter 260 with a

$$pulsation duty cycle = \frac{{P}_{tot}}{{P}_{cycle}} .$$

FIGS. 12A, 12B, 12C, and 12D exemplify such a condition.

Technical effects and solutions are provided by the novel modulation strategy for maximization of battery heating efficiency, particularly in preparation to charge the battery during cold temperatures or when charging the battery during cold temperatures. According to one or more embodiments, the modulation strategy delivers triangular waveforms to the load of the inverter by clamping two legs and commutating the third leg. The switches of the two clamped legs are modified every half-cycle of the output triangular waveforms. The third leg switches are commutated at the switching frequency (except for some rotor positions, where it may be possible to leave it clamped for most of the time). The commutation of the third leg is regulated to ensure minimal motor q-axis current in order to prevent the creation of electromagnetic torque in the motor. The control loop regulates the motor currents using the disclosed modulation and ensures zero q-axis current and negligible electromagnetic torque. According to one or more embodiments, the intermittent operation (the pulsation duty cycle) of the disclosed modulation (or any other modulation strategy) regulates the average battery heating power while allowing operation at the desired heating efficiency defined by the properties of the load currents (e.g., frequency, shape, amplitude, vector). The modulation strategy regulates heating efficiency by modifying waveform shape, frequency, and amplitude to balance battery and load (motor) losses. According to one or more embodiments, the control coordination defines the best waveform properties for different operating conditions including rotor loss temperature estimation (observer plus lookup table for losses) because the rotor can present high magnetic losses due to a pulsating magnetic field. The disclosed method of high voltage battery heating can still function when at least one high voltage load(s) (e.g., AC compressor control module, accessory power module, high voltage heater, etc.) is operational on the high voltage bus connected to the battery terminals. The disclosed method of high voltage battery heating can function when the high voltage battery is being charged via DC fast charge terminals in constant current mode at a selectable average charging current based on battery temperature and state of charge (SOC). The disclosed method of high voltage battery heating is applied when the high voltage battery is being charged via DC fast charge terminals in constant current mode and at least one high voltage load is operational on the high voltage bus connected to the battery terminals.

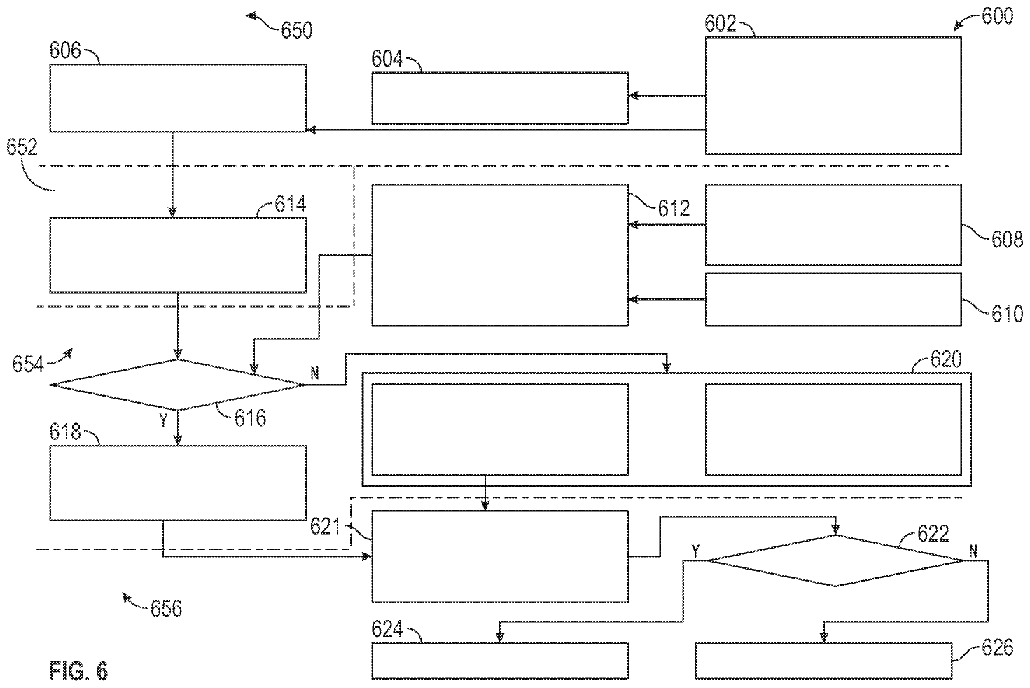

FIG. 7 is a flowchart of a computer-implemented method 700 for providing modulation strategy for maximization of battery heating efficiency in accordance with an exemplary embodiment. Reference can be made to any of the figures discussed herein.

At block 702 of the computer-implemented method 700, the control system 302 causes an inverter 260 to output (e.g., at output node 220A of leg 230A) a first electrical current having a first triangular waveform 411 to a motor 250. At block 704, the control system 302 causes the inverter 260 to output (e.g., at output node 220C of leg 230C) a second electrical current having a second triangular waveform 415 to the motor 250, the first and second triangular waveforms 411 and 415 being out of phase, for example, by 180°. At block 706, the control system 302 causes the inverter 260 to output (e.g., at output node 220B of leg 230B) a third electrical current to the motor 250, the first electrical current, the second electrical current, and the third electrical current being drawn from the high voltage battery 210.

In accordance with one or more embodiments, the control system 302 is configured to cause switching at every half-cycle (e.g., half period (T₀+T/2)) for the first triangular waveform 411 and the second triangular waveform 415. Increasing a pulsation duty cycle of the first triangular waveform, the second triangular waveform, and a third waveform (e.g., a third triangular waveform) of the third electrical current increases heating of the high voltage battery. The inverter 260 includes a first set of switches 201 and 202, and a second set of switches 205 and 206, and a third set of switches; the control system 302 is configured to input at least a first modulated signal to the first set of switches 201 and 202, and a second modulated signal to the second set of switches 205 and 206, and a third modulated signal to the third set of switches to cause the inverter 260 to output the first triangular waveform 411, the second triangular waveform 415, and a third triangular waveform respectively, the first modulated signal and the second modulated signal causing an opposite logic signal (e.g., depicted in FIG. 4A) in the first set of switches and the second set of switches.

Further, in accordance with one or more embodiments. The third electrical current has a third triangular waveform. Unbalanced phase relationships among first triangular waveform 411, the second triangular waveform 415, and the third triangular waveform cause heating of the high voltage battery 210, as depicted in FIGS. 5C and 5D. The unbalanced phase relationships draw alternating current from the high voltage battery in order to generate the heating in the high voltage battery. A combination of the first, second, and third electrical currents does not create any q-axis motor current such that no electromagnetic torque is generated in the motor.

For explanation purposes and not limitation, example space vector map is discussed below. The definition of the two legs that are clamped depends on the rotor position of the motor 250. Based on the rotor position angle ηᵣ, six sectors can be defined. The legs that are clamped in each sector are described below. Legs A, B, and C can be representative of legs 230A, 230B, and 230C, respectively.
Sector 1 (0≤ηᵣ<60°): the clamped legs are legs A and C, while leg B is commuting.
Sector 2 (60≤ηᵣ<120°): the clamped legs are legs B and C, while leg A is commuting.
Sector 3 (120 ≤ηᵣ<180°): the clamped legs are legs A and B, while leg C is commuting.
Sector 4 (180 ≤ηᵣ<240°): the clamped legs are legs A and C, while leg B is commuting.
Sector 5 (240 ≤ηᵣ<300°): the clamped legs are legs B and C, while leg A is commuting.
Sector 6 (300 ≤ηᵣ<360°): the clamped legs are legs A and B, while leg C is commuting.

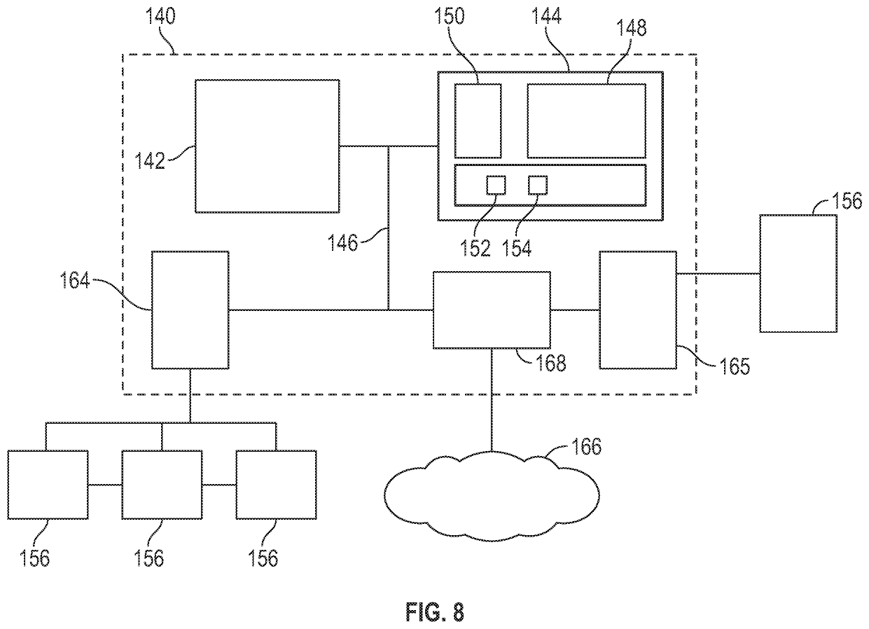

The third leg (not clamped one) is switching to achieve the desired reference vector as explained below. Table 1 below shows the possible space vectors that can be achieved at each sector when applying the clamped legs restrictions listed above. FIG. 9 represents these space vectors, which correspond to the same ones of a typical space vector pulse width modulation (SVPWM). FIG. 9 shows sectors 1, 2, 3, 4, 5, and 6 traversing in a counterclockwise direction. Line 902 illustrates the D-axis while line 904 illustrates the Q-axis.

TABLE 1

| | Possible space vectors | | | |
|---|---|---|---|---|
| | t < T/2 (first half of the | | t > T/2 (second half of the | |
| Sector | cycle) | | cycle) | |
| 1 | V1 (1, 0, 0) | V2 (1, 1, 0) | V4 (0, 1, 1) | V5 (0, 0, 1) |
| 2 | V2 (1, 1, 0) | V3 (0, 1, 0) | V5 (0, 0, 1) | V6 (1, 0, 1) |
| 3 | V3 (0, 1, 0) | V4 (0, 1, 1) | V6 (1, 0, 1) | V1 (1, 0, 0) |
| 4 | V4 (0, 1, 1) | V5 (0, 0, 1) | V1 (1, 0, 0) | V2 (1, 1, 0) |
| 5 | V5 (0, 0, 1) | V6 (1, 0, 1) | V2 (1, 1, 0) | V3 (0, 1, 0) |
| 6 | V6 (1, 0, 1) | V1 (1, 0, 0) | V3 (0, 1, 0) | V4 (0, 1, 1) |

It is noted that in space vectors (state of leg A, state of leg B, state of leg C) 1 means that the switch connected to the VDC+ is on. VDC+ is the positive power rail of the high voltage battery 210.

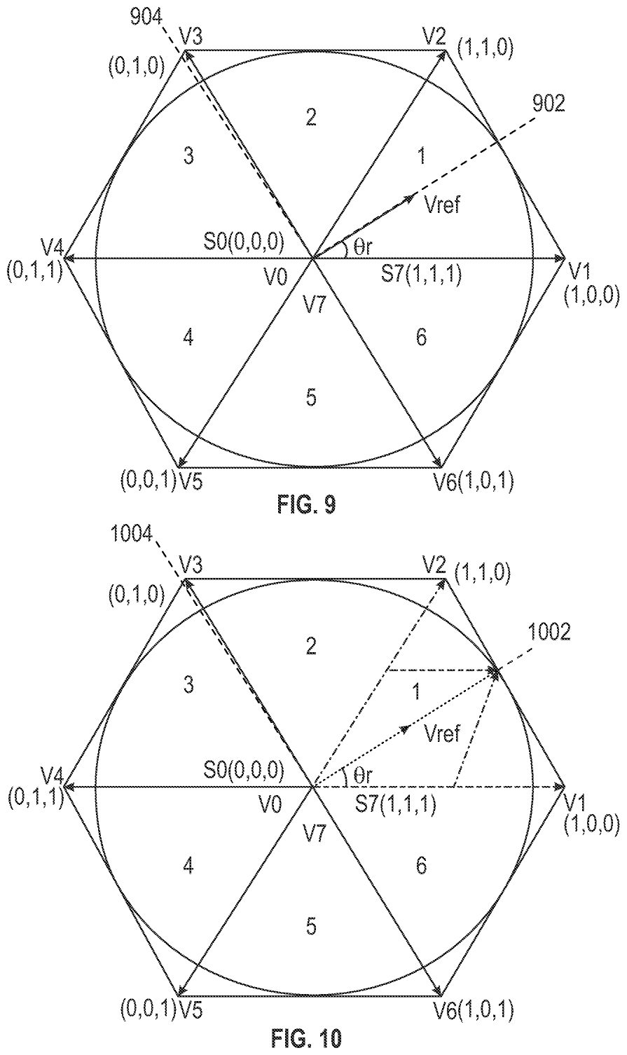

FIG. 10 illustrates space vector example. FIG. 10 shows sectors 1, 2, 3, 4, 5, and 6 traversing in a counterclockwise direction. Line 1002 illustrates the D-axis while line 1004 illustrates the Q-axis. In a similar manner to the SVPWM strategy, the reference vector V_{ref} can be achieved by a linear combination of the two vectors by which the sector where the reference vector falls into is limited (e.g., these vectors are V₁ and V₂ in FIG. 10). However, here, no zero vectors (e.g., SV7 (0,0,0)) are used. In a similar approach to the SVPWM strategy, the dwell time of each state within a switching cycle can be calculated using the scalar projection of the reference vector over the sectors space vectors that obeys the equation below:

\vec{V}_{ref}=TₐVₐ+T_{b}V_{b}, where Tₐ is the time at vector Vₐ and T_{b} is the time at vector V_{b}. Note that to switch from vector Vₐ to V_{b}, only the switches of a single inverter leg need to be turned on or off, allowing the other legs to be clamped for half the period. Vₐ and V_{b} can be selected to be any of the six vectors V1-V6.

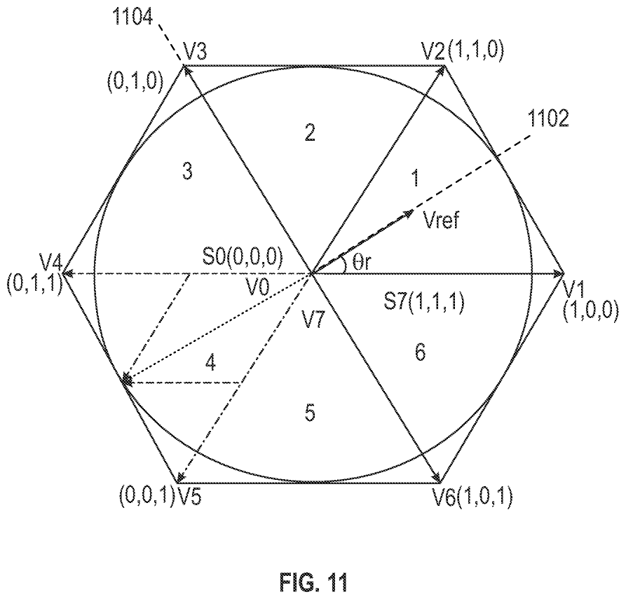

The reference vector phase angle, varies twice per cycle of the triangular waveform by 180 degrees (as seen in FIGS. 10 and 11). At these instants, the two clamped legs change their states to allow for using the states V4 and V5, that are 180 degrees shifted from V1 and V2, respectively. The Vref is now synthesized by a linear combination of V4 and V5, as shown in FIG. 11. FIG. 11 shows sectors 1, 2, 3, 4, 5, and 6 traversing in a counterclockwise direction. Line 1102 illustrates the D-axis while line 1104 illustrates the Q-axis. It should be appreciated that although the method above has been explained for a reference vector in the first sector, the example applies by analogy and can be extended to any sector. Additionally, following traditional operation of VSI, dead time can be inserted to the gate signals to ensure no DC-link short circuit via any inverter leg.

FIG. 8 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module 152 may be included for performing functions related to monitoring a propulsion system, and a module 154 may be included to perform functions related to switching between operating modes. The computer system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure be limited to the particular embodiments disclosed, but will include all embodiments falling within the scope thereof.

What is claimed is:

1. A system comprising:
an inverter coupled to a high voltage battery and a motor; and
a control system coupled to the inverter, wherein the control system is configured to control the inverter to output a first electrical current having a first triangular waveform to the motor, a second electrical current having a second triangular waveform to the motor, and a third electrical current to the motor, the first and second triangular waveforms being out of phase.

2. The system of claim 1, wherein the control system is configured to cause switching at every half-cycle for the first triangular waveform and the second triangular waveform.

3. The system of claim 1, wherein increasing a pulsation duty cycle of the first triangular waveform, the second triangular waveform, and a third waveform of the third electrical current increases heating of the high voltage battery.

4. The system of claim 1, wherein:
the inverter comprises a first set of switches, a second set of switches, and a third set of switches; and
the control system is configured to input at least a first modulated signal to the first set of switches, a second modulated signal to the second set of switches, and a third modulated signal to the third set of switches to cause the inverter to output the first triangular waveform, the second triangular waveform, and a third waveform, respectively, the first modulated signal and the second modulated signal causing an opposite logic signal in the first set of switches and the second set of switches.

5. The system of claim 1, wherein:
the third electrical current has a third triangular waveform; and
unbalanced phase relationships among the first triangular waveform, the second triangular waveform, and the third triangular waveform cause a heating of the high voltage battery.

6. The system of claim 5, wherein the unbalanced phase relationships draw alternating current from the high voltage battery in order to generate the heating in the high voltage battery.

7. The system of claim 1, wherein a combination of the first, second, and third electrical currents does not create any q-axis motor current such that no electromagnetic torque is generated in the motor of a vehicle.

8. A system comprising:
an inverter coupled to a high voltage battery and a motor, the inverter comprising a first set of switches, a second set of switches, and a third set of switches coupled to the high voltage battery; and
a control system coupled to the inverter, the control system comprising a memory having computer readable instructions and a processing device for executing the computer readable instructions in the memory;
wherein the control system is configured to control the first set of switches of the inverter to output a first electrical current having a first triangular waveform to the motor, control the second set of switches of the inverter to output a second electrical current having a second triangular waveform to the motor, and control the third set of switches of the inverter to output a third electrical current to the motor, the first and second triangular waveforms being out of phase.

9. The system of claim 8, wherein the control system is configured to cause switching at every half-cycle for the first triangular waveform and the second triangular waveform.

10. The system of claim 8, wherein increasing a pulsation duty cycle of the first triangular waveform, the second triangular waveform, and a third waveform of the third electrical current increases a heating of the high voltage battery.

11. The system of claim 8, wherein the control system is configured to input at least a first modulated signal to the first set of switches, a second modulated signal to the second set of switches, and a third modulated signal to the third set of switches to cause the inverter to output the first triangular waveform, the second triangular waveform, and a third triangular waveform, respectively, the first modulated signal and the second modulated signal causing an opposite logic signal in the first set of switches and the second set of switches.

12. The system of claim 8, wherein:
the third electrical current has a third triangular waveform; and
unbalanced phase relationships among the first triangular waveform, the second triangular waveform, and the third triangular waveform cause a heating of the high voltage battery.

13. The system of claim 12, wherein the unbalanced phase relationships draw alternating current from the high voltage battery in order to generate the heating in the high voltage battery.

14. The system of claim 8, wherein a combination of the first, second, and third electrical currents does not create any q-axis motor current such that no electromagnetic torque is generated in the motor of a vehicle.

15. A method for heating a high voltage battery, the method comprising:
causing, by a control system, an inverter to output a first electrical current having a first triangular waveform to a motor;
causing, by the control system, the inverter to output a second electrical current having a second triangular waveform to the motor, the first and second triangular waveforms being out of phase; and
causing, by the control system, the inverter to output a third electrical current to the motor, the first electrical current, the second electrical current, and the third electrical current being drawn from the high voltage battery.

16. The method of claim 15, wherein the control system is configured to cause switching at every half-cycle for the first triangular waveform and the second triangular waveform.

17. The method of claim 15, wherein increasing a pulsation duty cycle of the first triangular waveform, the second triangular waveform, and a third waveform of the third electrical current increases heating of the high voltage battery.

18. The method of claim 15, wherein:
the inverter comprises a first set of switches, a second set of switches, and a third set of switches; and
the control system is configured to input at least a first modulated signal to the first set of switches, a second modulated signal to the second set of switches, and a third modulated signal to the third set of switches to cause the inverter to output the first triangular waveform, the second triangular waveform, and a third triangular waveform, respectively, the first modulated signal and the second modulated signal causing an opposite logic signal in the first set of switches and the second set of switches.

19. The method of claim 15, wherein:
the third electrical current has a third triangular waveform; and
unbalanced phase relationships among the first triangular waveform, the second triangular waveform, and the third triangular waveform cause a heating of the high voltage battery.

20. The method of claim 19, wherein the unbalanced phase relationships draw alternating current from the high voltage battery in order to generate the heating in the high voltage battery.
